(19) United States
(12) Patent Application Publication
(10) Pub. No.: US 2017/0316447 A1
(43) Pub. Date: Nov. 2, 2017

(54) Method and System for Supporting Intelligent Export and Integration of Analytic System Data

(71) Applicant: Oracle America, Inc., Redwood Shores, CA (US)

(72) Inventors: Daniel E. Fichter, New York, NY (US); Christopher R. Tsoufakis, Salt Lake City, UT (US); Nikki K. Gomez, Brooklyn, NY (US); Aniq Rahman, New York, NY (US); Jonah Goodhart, New York, NY (US); Michael Garrett Seiler, Scarsdale, NY (US); Suryansh Agarwal, West Orange, NJ (US); Theodore V. McConnell, Cincinnati, OH (US)

(73) Assignee: Oracle America, Inc., Redwood Shores, CA (US)

(21) Appl. No.: 14/213,569

(22) Filed: Mar. 14, 2014

Related U.S. Application Data
(60) Provisional application No. 61/785,899, filed on Mar. 14, 2013.

(51) Int. Cl. G06Q 30/02

(52) U.S. Cl. CPC G06Q 30/0244

(57) ABSTRACT

A system and methods configured for intelligent export and integration of analytics system data, by which user input either drives or controls a control mechanism (e.g., instruction set or a programming language), which allows or executes export of data into downstream databases and programs in a way that allows direct use of the data by those systems without use of manual or a case-by-case reformatting or importation processes. The control mechanism serves as a powerful tool for users to use for exporting data directly from a database into templates or downstream data bases.

### CROSS-REFERENCE TO RELATED APPLICATIONS

The present application claims the benefit under 35 U.S.C. §119(e) of U.S. Provisional Application Ser. No. 61/785,899, entitled “Method and System for Supporting Intelligent Export and Integration of Analytic System Data,” filed on Mar. 14, 2013, the entire contents of which are incorporated herein by reference.

### BACKGROUND OF THE INVENTION

### 1. Field of the Invention

The present invention relates to ways of exporting data and more particularly to a system and method for supporting intelligent export and integration of analytic system data in a distributed environment.

### 2. Description of the Related Art

The Internet and other types of on-line communication have become increasingly popular to the point where they now compete with traditional media such as print media and broadcast media for the attention of users. Due to the large amount of web pages available for users to view worldwide, online content creation and publication become a huge business.

As a consequence, measurement of data generated by electronic media has become commonplace. This has given rise to creation of hundreds and thousands of analytic databases and systems that are dedicated for this purpose. Often these systems are products offered by analytics companies dedicated to generating metrics or specially created to support the information needs of a particular enterprise. Because these systems are customized to measure or analyze particular aspects of a business process, for example, in this instance online advertising, they are normally narrow in scope. Yet, at the same time business questions are normally broad in scope. Thus, this creates a need for an analytics system that is configured to be able to manipulate its data into any form for presentation or for use by other analytic systems efficiently.

A typical mode for this type of integration is one of several standard forms of data “export.” These methods have names like “Tab Delimited,” “or Comma Delimited,” because they describe a way by which a user can specify how a particular computer system comprehends another computer system's data. Often, once data is exported from one system into another, it must be reformatted at the receiving end to be incorporated for purposes of the receiving or other systems that will utilize that data, and then imported into those other systems, or in some implementations, manually built in to other databases or presentations for use. Clearly, the tasks involved in these processes are time-consuming and cumbersome.

It would be advantageous to create a facility or mechanism, controlled by user input that manifests as a control or programming language, to allow export of data into downstream databases and programs in a way that allows direct and efficient use of the data by those systems without use of manual or a case-by-case reformatting or importation processes.

### SUMMARY OF THE INVENTION

The present invention provides a system that creates a facility or mechanism, in which user input either drives or controls a control mechanism (e.g., an execution module, an instruction set or a programming language), which allows or executes export of data into downstream databases and programs in a way that allows direct and efficient use of the data by those systems without use of manual or a case-by-case reformatting or importation processes. The control mechanism or execution module serves as a powerful tool for users to use for exporting data directly from a database where data of interest may be stored into templates or downstream data bases where the data is used. In some implementations, data reflecting user engagement with advertising may be exported to an analytics server for use of this data in optimizing advertising strategies.

In some implementations, the present invention includes a method and process for exporting data for an analytic system to a downstream template (e.g., on a downstream computer or server in a distributed environment) that is in a different location from where the data is obtained. The method uses a control module that is designed to facilitate the exportation of data. In one implementation, the control module may include an instruction set or a programming language (e.g., semantics and syntax, and an interpreter/compiler) that is designed specifically to facilitate the exportation of data from one system/computer to another.

In some implementations, the control module including a programming language and associated compiler/interpreter is configured to transform information in the form of data elements (e.g., fields) and to accommodate the specific data input requirements of the downstream template so that manual input is eliminated from the process of transmitting data to its ultimate destination and use. In some instances, the control module is configured with one or more operational parameters that cause transmission of data based, based at least in part on, considering flexible criteria involving timing and data values. In some instances, transmission may be scheduled or predetermined for when a particular field in the database reaches a certain threshold level. These mechanisms advantageously provide an efficient and and direct way to export data for quick use.

In some implementations, the control module is configured to provide a user-interface to the user, by which the user selects a template type from a list of presentation programs that are compatible with computer operating systems, for example, Microsoft Excel or Microsoft Power Point. The user-interface specifies the criteria for data to be included in the export and performs conditional logic on the data for export, to create new data elements to be exported. These elements are derived from the database from where the data is designated to be extracted, but does not have to be contained in, or defined by the database's data model. The user-interface is configured by the control module to specify the logic that controls the particular instances the fields that are to be exported based at least in part on, specific values of other data in the database, or data that is derived. The control module is configured to specify transformations, per field (or in particular fields), by data type and format. In some instances, the control module specifies timing and transmission particulars to control the actual export process. In some instances, the control module creates a process to automate regular transmissions. In some instances, the control module may further specify a mode of transmission, and a mode of signaling, by which the end user would be notified of transmission status.

The system and methods of the present invention may be implemented on one or more computer program products and are configured to provide or present a user-interface for display to a user, wherein the user-interface enables users to use tools to provide instructions that drive the intelligent export process, requiring little manual input through the export process.

### BRIEF DESCRIPTION OF THE DRAWINGS

The present invention is illustrated by way of example, and not by way of limitation in the figures of the accompanying drawings in which like reference numerals are used to refer to similar elements.

FIG. 1 is a block diagram illustrating an embodiment of a system executing intelligent mechanisms for exporting data in accordance with the present invention.

FIG. 2A is a block diagram illustrating various hardware components of an example analytics server in accordance with the present invention.

FIG. 2B is a block diagram illustrating various software components of the example analytics server in accordance with the present invention.

FIG. 3A is a block diagram illustrating various hardware/software components of an example client device.

FIG. 3B is a block diagram illustrating an example client application.

FIG. 4 is a flowchart of an example general method for intelligent exporting of data by a control module in accordance with the present invention.

FIG. 5 is a flow chart illustrating an example method for creating a template and export program and storing them on an analytics server (or other designated server).

FIG. 6 is a flow chart illustrating an example export program in accordance with the present invention.

FIG. 7 is a flow chart illustrating an example method for providing a user-interface to users to receive instructions to execute the export process.

FIG. 8 is a block diagram illustrating one embodiment of data storage in accordance with the present invention.

### DETAILED DESCRIPTION OF EMBODIMENTS

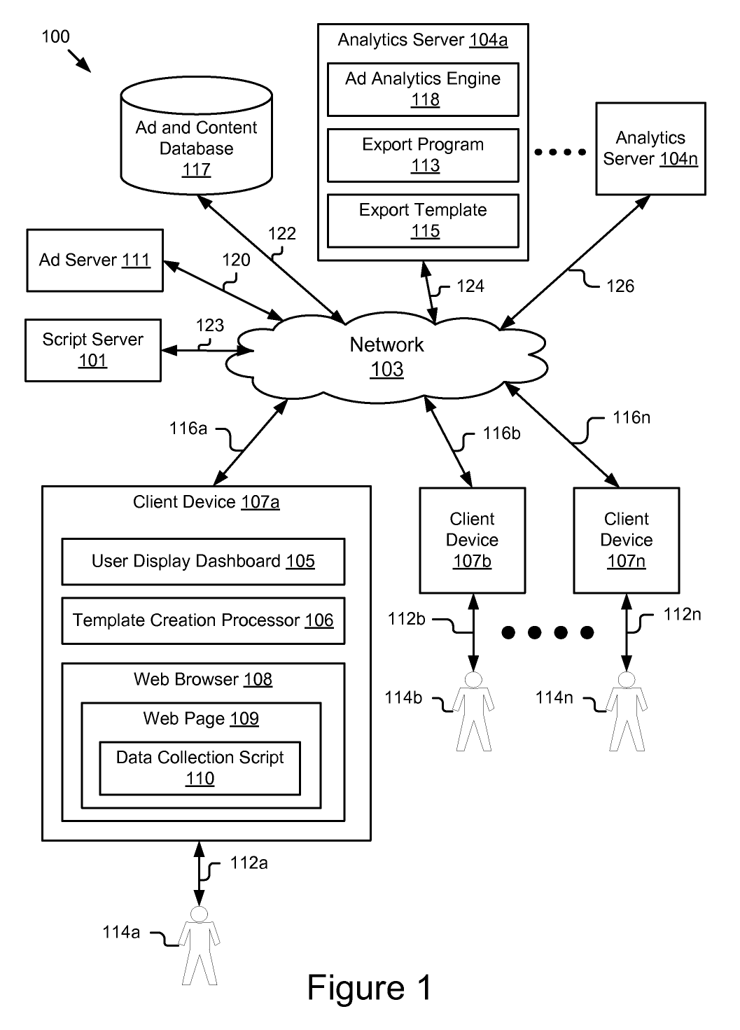

FIG. 1 illustrates a block diagram of one embodiment of the system 100 for executing an intelligent export process in a networked system (e.g., a measurement system for gauging user attention to advertising content in a distributed network of websites) by a control module configured to present a user-interface to receive instructions and automatically execute export protocols with little or no manual interference thereafter.

The system 100 is an intelligent system for supporting intelligent export and integration of analytic system data. The system 100 and methods of the present invention described here either utilize or are operated on one or more computing systems (with one or more computers, processors, and data storage devices) that are configured to communicate in a distributed environment coupled via a network. For many examples described in the specification below, data that is being exported or integrated may be any text, picture or video created and/or published by publishers on web pages which are accessible to users. Furthermore, for many examples in the specification below, the data may be online advertisements (ad) including any text, picture, or video, the purpose of which is advertising communication including any flash asset, any image of Internet Advertising Board (IAB) or industry standard width and height that is clickable including any recursion into iframes from the original page.

The illustrated system 100 includes a script server 101, an ad server 111, and one or more analytics servers 104-104n, an Ad-and-Content database 117, and one or more client devices 107a-107n that are accessed by users indicated by reference numerals 114a-114n. In the illustrated embodiment, these entities are communicatively coupled via a network 103. Although only three client devices 107a, 107b and 107n are illustrated, it should be recognized that any number of client devices 107n are available to any number of users 114n. Furthermore, while only one network 103 is coupled to the script server 101, the analytics servers, 104a-104n, the ad server 111, the Ad-and-Content Database 117, and the one or more client devices 107a, 107b, and 107n, in practice, any number of networks 103 can be connected to these entities. In one embodiment, the script server 101, the analytics servers, 104a-104n, and the ad server 111, are hardware servers including a processor, memory, and network communication capabilities.

The network 103 is a conventional type, wired or wireless, and may have any number of configurations such as a star configuration, token ring configuration or other configurations. Furthermore, the network 103 may comprise a local area network (LAN), a wide area network (WAN) (e.g., the Internet), and/or any other interconnected data path across which multiple devices may communicate. In yet another embodiment, the network 103 may be a peer-to-peer network. The network 103 may also be coupled to or includes portions of a telecommunications network for sending data in a variety of different communication protocols. In yet another embodiment, the network 103 includes Bluetooth communication networks or a cellular communications network for sending and receiving data such as via short messaging service (SMS), multimedia messaging service (MMS), hypertext transfer protocol (HTTP), direct data connection, WAP, email, etc.

The client device 107a is representative of client devices 107a, 107b, and 107n and is a conventional type of computing device, for example, a personal computer, a hardware server, a laptop computer, a tablet computer, or smart phone. The client devices 107a-107n, are coupled to the network 103 by signal lines 116a, 116b-116n, respectively. In one embodiment, the client device 107 is coupled to receive (e.g., download or otherwise view) content with online advertisements from the ad server 111 and other content from publishing sites or third party servers (not shown) but coupled in the illustrated distributed environment. The client device 107 includes the web browser 108 for presenting web pages 109 including online content and advertisements to the user or client 114a, 114b, through 114n, for viewing on their respective client devices 107a-107n. The web browser 108 on each of the client or user device 107a-107n presents advertisements and other online content, and receives input from the user or client 114a-114n as represented by signal lines 112a-112n. The signal lines 112a-112n represent interactions of the users, 114a-114n, with their respective devices 107a-17n (e.g., viewing or manipulating tools to receive or control viewing of the online content or otherwise instructions for executing the export process). The client device 107 also has a data-collection script 110 (either downloaded, installed, or otherwise embedded, to gather data) for ultimate user by the analytics servers 104a through 104n. In one embodiment, the data collection script 110 may be embedded on the web browser 108 by the script server 101. In another embodiment, the data collection script 110 may be placed on the web browser 108 by the ad server 111. In yet another embodiment, the data collection script 110 may be embedded on the web browser 108 by other content servers (not shown). The web browser 108 and the data collection script 110 are operable on the client devices 107a through 17n. The client device 107 also includes a user-display dashboard 105 (to provide the user-interface) and a template-creation processor 112, by which the user 114 selects an export template 115 (on Analytics Server 104a) selects for the export process.

In operation, a user 114 (a-n) creates (e.g., selects from a menu or otherwise) a particular template (e.g., export template 115 illustrated on the Analytics Server 104) by using a template creation processor 106 via the User-Display Dashboard 105 and stores it on the analytics server 104 (a-n). Next, the user 114 (a-n) either decides or designates the data from the analytic system for export. The user 114 (a-n) writes an export program 113 in the semantics and syntax specified by the Ad-Analytics engine 118 (e.g., an example of the control module), using the User-Display Dashboard 105, and stores it on the analytics server 104 (a-n).

The user 114 (a-n), by using the User-Display dashboard 105 specifies the location of the export program 113, and the location of the export template 115, to which the data is to be exported. It should be recognized that the export program 113 and the export template 114 may be located in other locations than are illustrated in the figures. The locations of the export program 113 and the export template 114 as illustrated are only for purposes of illustration. The export program 113, specified or written by the user 114 executes on the analytic server 104 (a-n), and populates data into the export template 115, designated by the template-creation processor 106.

In one embodiment, a user 114, by using the User-Display Dashboard 105 may decide to send data, for example, a picture, and several fields pertaining to advertising attention or engagement, such as “time-in-view,” and “percentage (%) in-view,” to a presentation program, for example, a Microsoft Power Point presentation. In this particular example, the user 114 may create (by selecting it from several displayed or otherwise) a template of the Power Point slide the user 114 wants to populate, by using the template creation processor 105, which is provided in the user-interface of the client device 107 (a-n).

The user 114 uses a facility, tools, or controls provided in the User-Display Dashboard to create the program that specifies which data to export, when, under what conditions, etc. This is facilitated by the configurations of the system 100. User input either drives or controls a control mechanism (e.g., in the Ad-Analytics Engine and either an instruction set or a programming language), which allows or executes export of data into downstream databases (e.g., the analytics server 104) and programs in a way that allows direct use of the data by those systems without use of manual or a case-by-case reformatting or importation processes. The control mechanism (e.g. Ad-Analytic Engine 118) serves as a powerful tool for users 114 to use for exporting data directly from a database (e.g., Ad-and-Content Database) into templates or downstream data bases.

The script server 101 is a computer program running on a hardware system for providing one or more data collection scripts 110 (e.g., configured to determine or measure user behavior of visibility of online advertisement content) to web pages 109. For example, the script server 101 may be a web server that creates and provides data collection scripts 101 for publishers to place (via content servers or the like) the scripts on web browsers 108. In one embodiment, the script server 101 may provide the data collection script 110 to a publisher that places the data collection script 110 on a web browser 108 that provides a web page containing content including advertisements for viewing by users or clients 114a-114n. In another embodiment, the ad server 111 is used to place the data collection script 110 on the web browser 108. The script server 101 is coupled to the network 103, by signal line 123, for providing data collection scripts 110 to be placed on the web browsers 108.

The ad server 111 is a computer program running on a hardware system for placing advertisements on websites and/or placing the data collection script 110 on web pages 109. For example, the ad server 111 may be a web server that receives advertisements from the ad preparation server or the advertising asset server (not shown) and delivers them to users or clients (114a-114n) or viewing websites. The ad server 111 is coupled to the network 103 by signal line 120 for receiving ads from the ad preparation server or the advertising asset server (not shown) and for delivering the ads to third party servers, sites or domains (not shown).

The analytics server 104 is a computer program running on a hardware system for facilitating intelligent export of data as designated by the user 114. The analytics server 104 comprises the Ad-Analytics Engine 118 and one or more export programs 113 and the export template 115. The operations of these elements were described above. The analytics server 104 is coupled to the network 103, by signal line 124, for communication with the other components of the system 100.

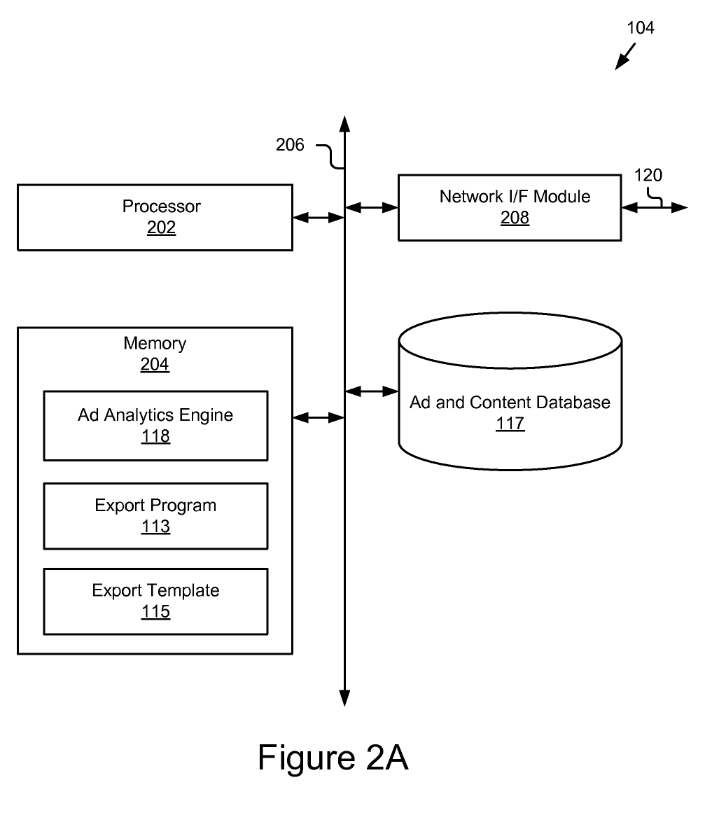

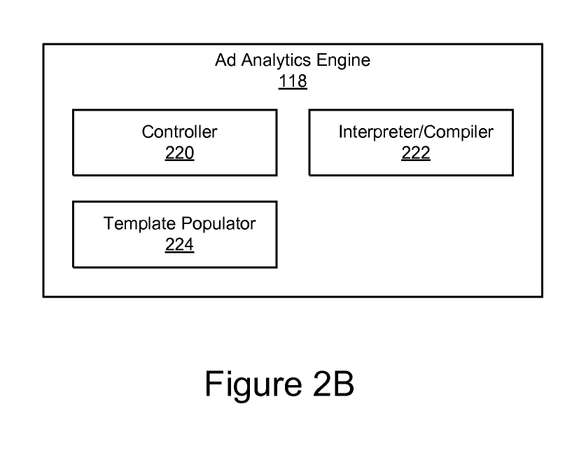

FIG. 2A is a block diagram of example hardware components of the analytics server 104 (or a server dedicated to facilitate the export process and receive data for measurement or analysis). In this embodiment, the analytics server 104 comprises: a processor 202, memory 204 with the Ad-Analytics Engine 118, the export program 113, and export template 114, a network I/F module 208, an Ad-and-Content database 117, and a bus 206.

The processor 202 comprises an arithmetic logic unit, a microprocessor, a general-purpose controller or some other processor array to perform computations and provide electronic display signals to a display device. The processor 202 is coupled to the bus 206 for communication with the other components via a signal line. The processor 202 processes data signals and may comprise various computing architectures including a complex instruction set computer (CISC) architecture, a reduced instruction set computer (RISC) architecture, or an architecture implementing a combination of instruction sets. Although only a single processor is shown in FIG. 2, multiple processors may be included. Other processors, operating systems, sensors, displays and physical configurations are possible.

The memory 204 stores instructions and/or data that may be executed by the processor 202. The memory 204 is coupled to the bus 206 via a signal line for communication with the other components via a signal line. The instructions and/or data may comprise code for performing any and/or all of the techniques described herein. The memory 204 may be a dynamic random access memory (DRAM) device, a static random access memory (SRAM) device, flash memory or some other memory device.

The network I/F module 208, as illustrated, is coupled to network 103, by a signal line 120, and is coupled to the bus 206. The network The network I/F module 208 includes ports for wired connectivity such as but not limited to USB, SD, or CAT-5, etc. The network I/F module 208 links the processor 202 to the network 103 that may in turn be coupled to other processing systems. The network I/F module 208 is configured to provide other connections to the network 103 using standard network protocols such as TCP/IP, HTTP, HTTPS and SMTP. In other embodiments, the network I/F module 208 includes a transceiver for sending and receiving signals using Wi-Fi, Bluetooth® or cellular communications for wireless communication. The network interface (I/F) module 208 provides a communication path for the components of the client device 107a-nto the network 103 and other systems.

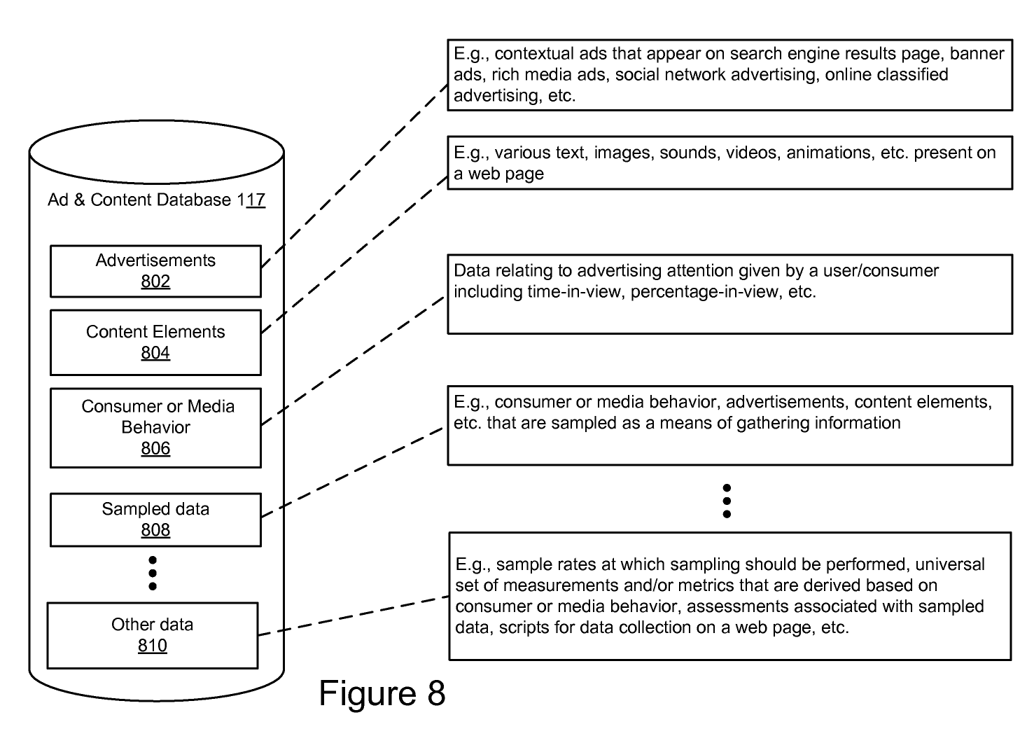

The Ad-and-Content database 117 is data storage for storing content and other data as illustrated in further detail with reference to FIG. 8. The Ad-and-Content database 117 is coupled to the bus 206. The Ad-and-Content storage 117 stores data, information and instructions used by the processor 202. Such stored information includes information on advertisements, content elements, consumer-or-media behavior, sampled data, or other information. In one embodiment, the Ad-and-Content storage 117 stores data received by the processor 202 as well as data generated during intermediate processes. In one embodiment, the Ad-and-Content database 117 is of conventional type. The Ad-and-Content database 117 is a non-volatile memory or similar permanent storage device and media such as a hard disk drive, a floppy disk drive, a CD-ROM device, a DVD-ROM device, a DVD-RAM device, a DVD-RW device, a flash memory device, or some other mass storage device for storing information on a more permanent basis. The Ad-and-Content database 117 is coupled by the bus 206 via a signal line for communication with other components. The Ad-and-Content database 117 will be described in further detail below with reference to FIG. 8.

In some implementations, the Ad-Analytics Engine 118 represents a control module that is designed to facilitate the exportation of data. In one implementation, the control module may include an instruction set or a programming language (e.g., semantics and syntax, and an interpreter/compiler) that is designed specifically to facilitate the exportation of data from one system/computer to another.

In some implementations, the control module (e.g., the Ad-Analytics Engine 118, either alone or with other components) includes a programming language and associated compiler/interpreter configured to transform information in the form of data elements (e.g., fields) and to accommodate the specific data input requirements of the downstream template (e.g., template 115) so that manual input (by the user 114) is eliminated from the process of transmitting data to its ultimate use. In some instances, the control module (e.g., Ad-Analytics 118) is configured with one or more operational parameters that cause transmission of data based, based at least in part on, flexible criteria involving timing and data values. In some instances, transmission may be scheduled or predetermined for when a particular field in the database reaches a certain threshold level. In some implementations, the control module (Ad-Analytics Engine 118) is configured to provide a user-interface (e.g., User-Display Dashboard 105) to the user 114, by which the user 114 selects a particular template type 115 from a list of presentation programs that are compatible with computer operating systems, for example, Microsoft Excel or Microsoft Power Point. The user-interface specifies the criteria for data to be included in the export and performs conditional logic on the data for export, to create new data elements to be exported. These elements are derived from the database (e.g., Ad-and-Content Database) from where the data is designated to be extracted, but does not have to be contained in, or defined by the database's data model. The user-interface is configured by the control module (e.g., Ad-Analytics Engine 118) to specify the logic that controls the particular instances the fields that are to be exported based at least in part on, specific values of other data in the database (e.g., Ad-and-Content Database 117), or data that is derived. The control module or Ad-Analytics Engine 118 in some instances is configured to specify transformations, per field, by data type and format. In some instances, the control module or Ad-Analytics Engine 118 specifies timing and transmission particulars to control the actual export process. In some instances, the control module or An-Analytics 118 creates a process to automate regular transmissions. In some instances, the control module or Ad-Analytics Engine 118 may further specify a mode of transmission, and a mode of signaling, by which the end user would be notified of transmission status.

FIG. 2B is a block diagram illustrating example software components of the Ad-Analytics Engine 118 of the analytics server 104, including a controller 220, an interpreter/compiler 222, and a template populator 224.

The controller 220 is software, code or routines for handling communications between the Ad-Analytics engine 118 and other components of the analytics server 104. For example, the controller 220 is coupled to receive export data from the data collection script 110 and deliver the export data to one or more other modules of the Ad-Analytics engine 118, e.g., the Interpreter/Compiler 222 or the template populator 224. In one embodiment, the controller 220 receives communication data from one or more other modules of the Ad-Analytics engine 118 and sends, via the network OF module 208 (FIG. 2A), the communication data to the next entity. The controller 220 is coupled to the bus 206 (FIG. 2A) for communications with other components of the analytics server 104. In some instances, the controller 220 may configure one or more operational parameters that cause transmission of data based, based at least in part on, considering flexible criteria involving timing and data values. In some instances, transmission may be scheduled, specified, or predetermined for when a particular field in the database reaches a certain threshold level. The threshold level may be specified either before or may be updated as needed.

The Interpreter/Compiler 222 is software, code or routines for interpreting and compiling data that is either received or identified for exporting. In some implementations, the Interpreter/Compiler 222 is an instruction set or a programming language (e.g., semantics and syntax) that is designed specifically to facilitate the exportation of data from one system/computer to another. In some implementations, it includes a programming language configured to transform information in the form of data elements (e.g., fields) and to accommodate the specific data input requirements of the downstream template so that manual input is eliminated from the process of transmitting data to its ultimate use.

The template populator 224 is coupled by the network 103 to one or more client devices 107a-107n and populates the export template 115 as designated.

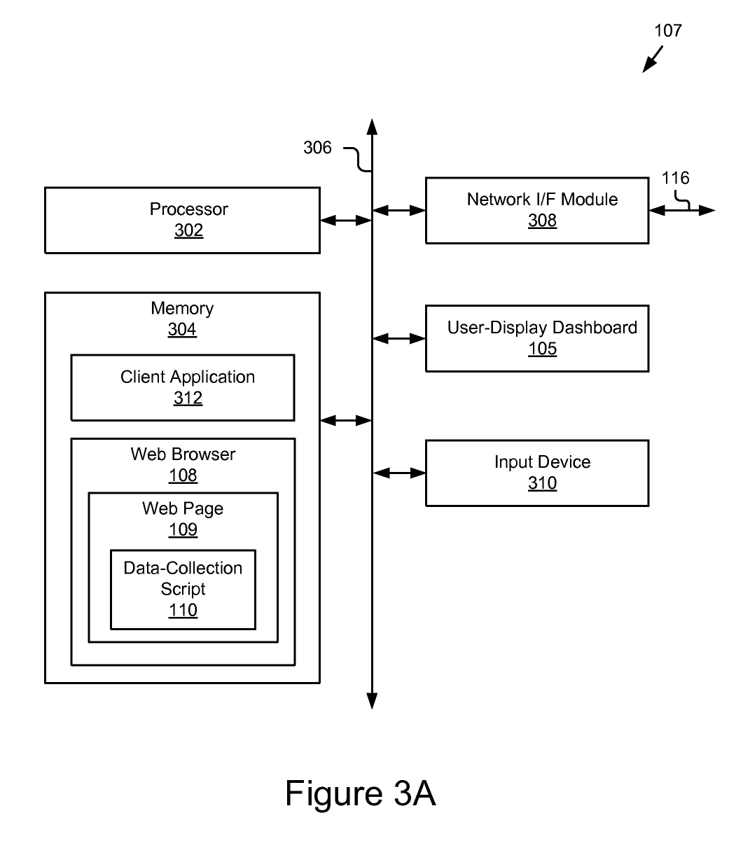

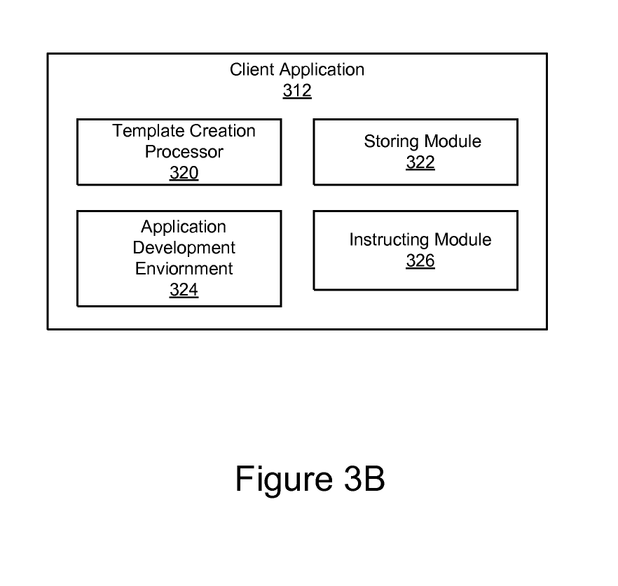

Referring now to FIG. 3A, example hardware and software components of an example client device 107a-107n are illustrated. An example client device 107a-107n may be of conventional type, a computing device, for example, a personal computer, a hardware server, a laptop computer, a tablet computer or smart phone. The client devices 107a-107n, are coupled to the network 103 by signal lines 116. The client devices 107a-107n, include a processor 302, memory 304, a network I/F module 308, the User-Display Dashboard 105, and an input device 310.

In one implementation, the client device 107 is coupled to receive content with online advertisements from the ad server 111 and other content from publishing sites or third party servers (not shown). The client device 107 includes the web browser 108 for presenting web pages 109 including online content and advertisements to the user or client 114a, 114b, through 114n. The web browser 108 on each of the client or user device 107a-107n presents advertisements and other content, and receives input from the user or client 114a-114n. The web browser 108 and the data collection script 110 on the web page 109 are operable on the client devices 107a through 17n. In one embodiment, the data collection script 110 may be embedded on the web browser 108 from the script server 101. In another embodiment, the data collection script 110 may be placed on the web browser 108 by the ad server 111. In yet another embodiment, the data collection script 110 may be embedded on the web browser 108 by the content server 102. A client application 312 may contain the template-creation processor 105, by which the user 114 creates (as in, selects or requests) the export template 115 for populating with data designated by the user 114. The user 114 by the User-Display Dashboard 105 executes the controls necessary for these operations.

The processor 302 comprises an arithmetic logic unit, a microprocessor, a general-purpose controller or some other processor array to perform computations and provide electronic signals to the other components. The processor 302 is coupled to the bus 306 for communication with the other components via a signal line. The processor 302 processes data signals and may comprise various computing architectures including a complex instruction set computer (CISC) architecture, a reduced instruction set computer (RISC) architecture, or an architecture implementing a combination of instruction sets. Although only a single processor is shown in FIG. 3A, multiple processors may be included. Other processors, operating systems, sensors, displays and physical configurations are possible.

The memory 304 stores instructions and/or data that may be executed by the processor 302. The memory 304 is coupled to the bus 306 via a signal line for communication with the other components via a signal line. The instructions and/or data may comprise code for performing any and/or all of the techniques described herein. The memory 304 may be a dynamic random access memory (DRAM) device, a static random access memory (SRAM) device, flash memory or some other memory device.

The network I/F module 308 is coupled to network 103 by a signal line 116 (a-n) and coupled to the bus 306. The network I/F module 308 includes ports for wired connectivity such as but not limited to USB, SD, or CAT-5, etc. The network I/F module 308 links the processor 302 to the network 103 that may in turn be coupled to other processing systems. The network I/F module 308 is configured to provide other connections to the network 103 using standard network protocols such as TCP/IP, HTTP, HTTPS and SMTP. In other embodiments, the network I/F module 308 includes a transceiver for sending and receiving signals using Wi-Fi, Bluetooth® or cellular communications for wireless communication. The network interface (I/F) module 308 provides a communication path for the components of the client device 107a-n to the network 103 and other systems.

Referring now to FIG. 3B, an example client application 312 is illustrated. The client application 312 may comprise the template-creation processor 320, a storing module 322, an application-development environment 324, and an instructing module 326. Each of these is software, code or routines for executing the export process. In particular, the template-creation processor 320 is configured to create, select, or request a template 115 for populating with the data to be exported. The storing module 322 controls storage of the data designated for export. The application-development environment 324 supports the operations of the export process and the instructing module 326 provides the instructions on the operations parameters. As example, these operation parameters may include timing or data values. It should be recognized that any of parameters may be defined.

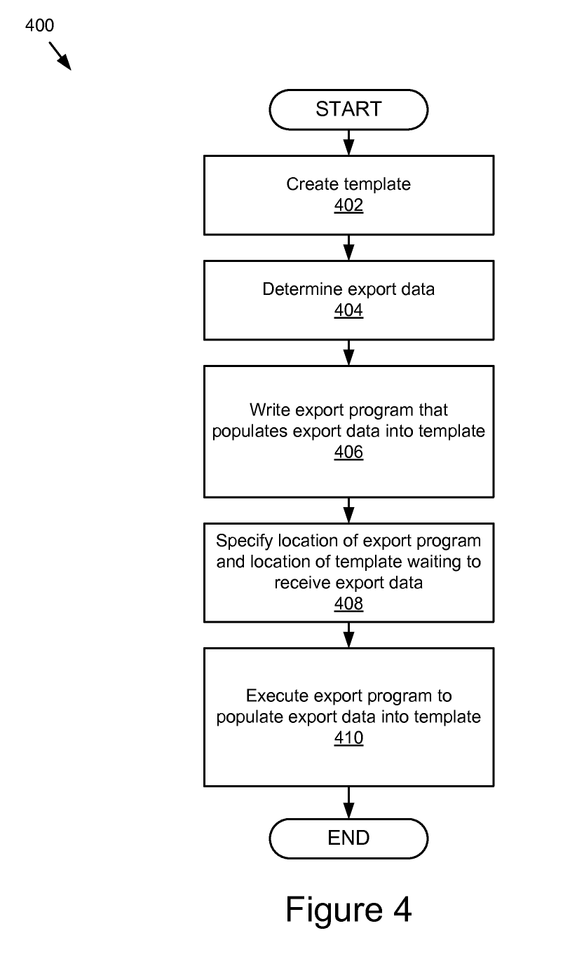

Referring now to FIG. 4, one embodiment of a general method 400 in accordance with the present invention, for executing the intelligent export and integration of data is illustrated. The method 400 begins with one or more operations designated by block 402, for creating the template (e.g., template 115). By creating a template, it should be recognized that all instances of generating, requesting, or selecting a template 115 from a menu are covered by this description. The method 400 continues to block 404, including one or more operations for determining the data for export or “export data.” The method 400 proceeds to the next block 406 including one or more operations for writing a program for export that populates export data into the template 115. The method 400 proceeds to the next block 408 of one or more operations for specifying location of the program for export (e.g., export program 113) and the location of the template (e.g., 115). It should be recognized that these locations could be different than those illustrated. The method 400 continues to block 410 including one or more operations for executing the export program to populate export data into the designated template (e.g., 115). The method proceeds to an indication of “END,” which is simply to illustrate an end to the sequence of operations described above. It should be recognized that the method 400 described is by way of example and it may either include additional operations not described here or exclude any of the operations that are described.

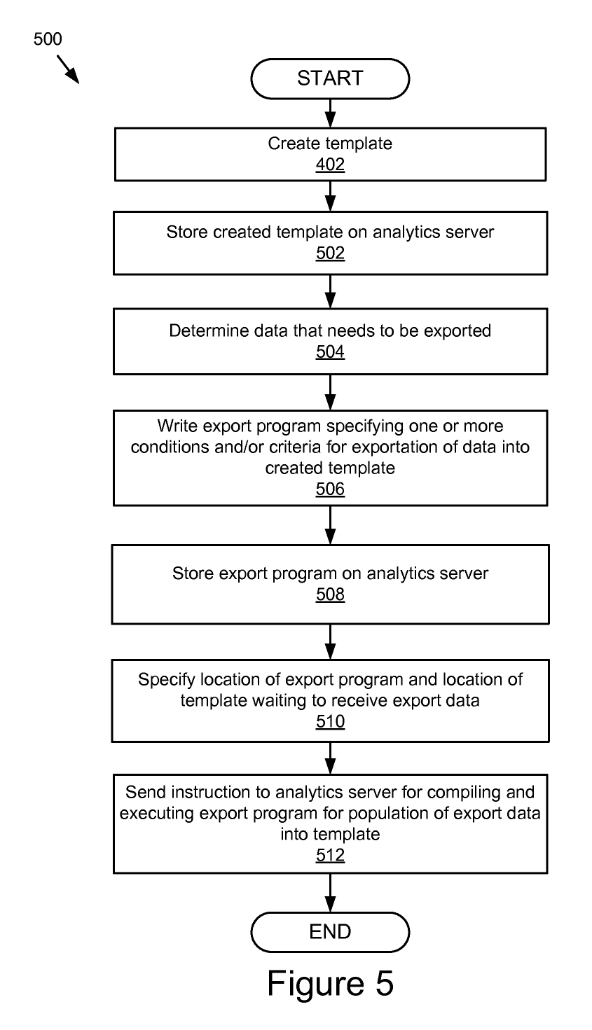

Referring now to FIG. 5, an example method 500 illustrating the method for creating the template and export program is described. The method 500 begins by one or more operations designated by block 402 (as in FIG. 4) for creating the template. The method 500 proceeds to the next block 504, including one or more operations for storing the template created on the analytics server 104. These operations illustrate the flexible nature of the present method, by which, users 114 in some instances may designate where to locate the template 115. The method 500 proceeds to the next block 506, including one or more operations for writing a program for export specifying one or more conditions and/or criteria for exportation of data into the created template. The method 500 proceeds to the next block 508 including one or more operations for storing the program for export on the analytics server 104. The method 500 proceeds to the next block 510, including one or more operations, for specifying the location of the program for export and the location of the template that is waiting to receive the export data. The method 500 proceeds to the next block 512 including one or more operations for sending instructions to analytics servers 104 for compiling and executing the export program for population of export data into the template 115. The method proceeds to an indication of “END,” which is simply to illustrate an end to the sequence of operations described above. It should be recognized that the method 400 described is by way of example and it may either include additional operations not described here or exclude any of the operations that are described.

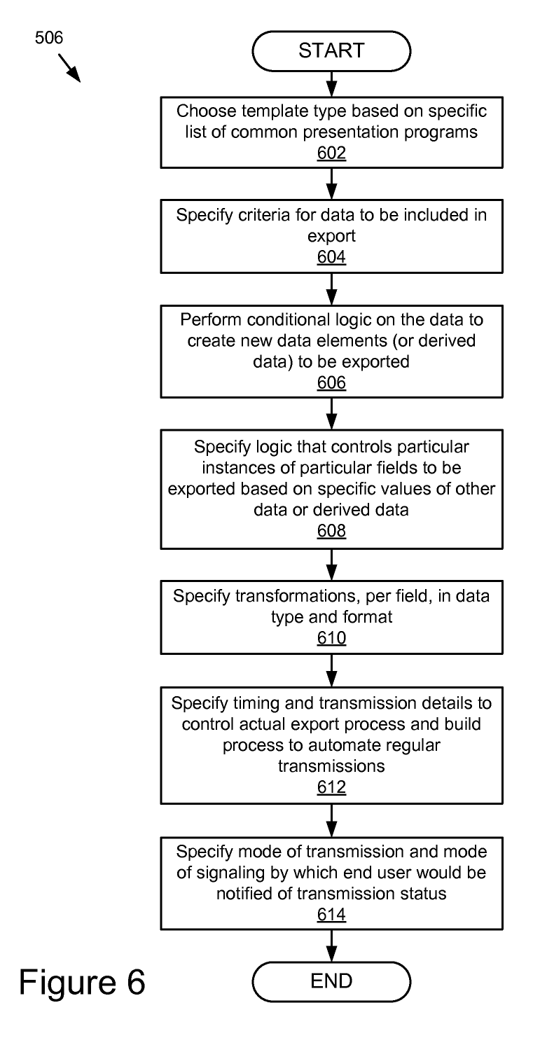

Referring now to FIG. 6, example operations illustrated in block 506 (FIG. 5) are illustrated and described. The method 506 begins and proceeds to a block 602 including one or more operations for choosing the template type based on a specific list of common presentation programs that are available in the industry. It should be recognized that custom programs may be included and recent updates or programs installed and downloaded. The method 600 proceeds to the next block 604 for specifying criteria for the data to be included in the export process. The method 600 proceeds to the next block 606 including one or more operations for performing conditional logic on the data to be exported to create new data elements (or derived data) to be exported. The method 600 proceeds to the next block 608 including one or more operations for specifying the logic that controls the instances of the fields to be exported based on specific values of other data or derived data. The method 600 proceeds to the next block 610 including one or more operations for specifying the timing and transmission details to control the actual export process and to build a process to automate regular transmissions. The method 600 proceeds to the next block 614 including one or more operations for specifying the mode of transmission, the mode of signaling by which the end user may be notified of the transmission status. For this, a signaling and mode of transmission schemes may be either adopted, adapted from those that exist, or newly devised and incorporated. The method proceeds to an indication of “END,” which is simply to illustrate an end to the sequence of operations described above. It should be recognized that the method 400 described is by way of example and it may either include additional operations not described here or exclude any of the operations that are described.

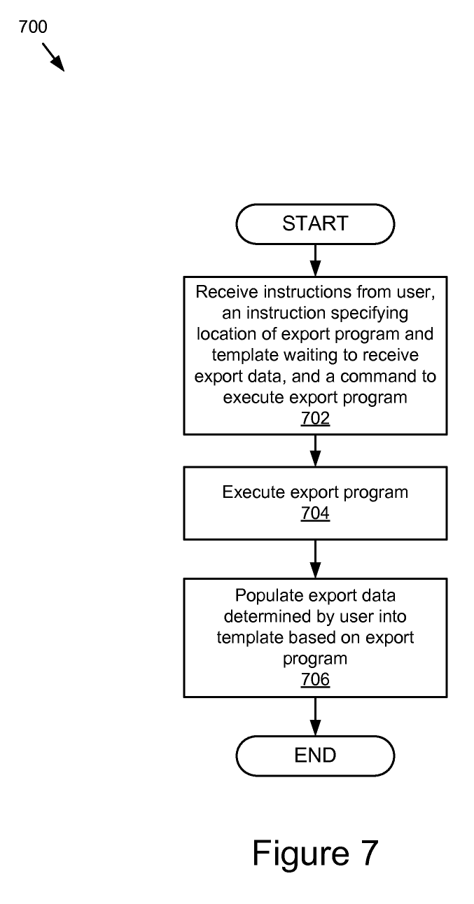

Referring now to FIG. 7, the method 700 for receiving user instructions and executing the export program starts and proceeds to block 702, including one or more operations for receiving instructions from a user, where a first instruction specifies the location of the export program 113 and the template 115 waiting to receive the export data and a second instruction commands execution of the export program. The method 700 proceeds to the next block 704 including one or more operations for executing the program for export. The method 700 proceeds to the next block 706 including one or more operations for populating export data determined by a user into the template 115 based on the program for export (as instructed by the export program).

Referring now to FIG. 8, one embodiment of an Ad-and-Content database 117 in accordance with the present invention is illustrated and described. The Ad-and-Content database 117 is data storage for storing data useful for the Ad-Analytics engine 118 to perform its functionality. In the illustrated embodiment, the Ad-and-Content database 117 stores “Advertisements” 802, including, for example, contextual advertisements that appear on search engine results, page, banner advertisements, rich media advertisements, social network advertising, online classified advertising etc. The Ad-and-Content database 117 also includes “Content Elements” 804, “Consumer-or-Media Behavior (on Web-Connected Devices)” 806, “Sampled data” 808, and other types of data indicated by reference numeral 810. Examples of content elements 804 are various text, images, sounds, videos, animations, etc., which are present on a web page. Examples of data reflecting Consumer-or-Media Behavior 806 include data relating to advertising attention given by a user/consumer including time-in-view, percentage-in-view etc. Examples of sampled data 808 include sample rates at which sampling should be performed, universal set of measurements and/or metrics that are derived based consumer or media behavior, assessments associated with sampled data, scripts for data collection on a web page etc.

Systems and methods for intelligent export and integration of data are described here. In the above description, for purposes of explanation, numerous specific details were set forth. It will be apparent, however, that the disclosed technologies can be practiced without these specific details. In other instances, structures and devices are shown in block diagram form. For example, the disclosed technologies are described in one embodiment below with reference to user interfaces and particular hardware. Moreover, the technologies are disclosed above primarily in the context of the Internet and on-line advertising; however, the disclosed technologies apply to other types of advertising.

Reference in the specification to “one embodiment” or “an embodiment” means that a particular feature, structure, or characteristic described in connection with the embodiment is included in at least one embodiment of the disclosed technologies. The appearances of the phrase “in one embodiment” in various places in the specification are not necessarily all referring to the same embodiment.

Some portions of the detailed descriptions above were presented in terms of processes and symbolic representations of operations on data bits within a computer memory. A process can generally be considered a self-consistent sequence of steps leading to a result. The steps may involve physical manipulations of physical quantities. These quantities take the form of electrical or magnetic signals capable of being stored, transferred, combined, compared, and otherwise manipulated. These signals may be referred to as being in the form of bits, values, elements, symbols, characters, terms, numbers or the like.

These and similar terms can be associated with the appropriate physical quantities and can be considered labels applied to these quantities. Unless specifically stated otherwise as apparent from the prior discussion, it is appreciated that throughout the description, discussions utilizing terms such as “processing” or “computing” or “calculating” or “determining” or “displaying” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosed technologies may also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The disclosed technologies can take the form of an entirely hardware embodiment, an entirely software embodiment or an embodiment containing both hardware and software elements. In one embodiment, the technology is implemented in software, which includes but is not limited to firmware, resident software, microcode, etc.

Furthermore, the disclosed technologies can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

Finally, the processes and displays presented herein may not be inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the disclosed technologies were not described with reference to any particular programming language. It will be appreciated that a variety of programming languages may be used to implement the teachings of the technologies as described herein.

The foregoing description of the embodiments of the present techniques and technologies has been presented for the purposes of illustration and description. It is not intended to be exhaustive or to limit the present techniques and technologies to the precise form disclosed. Many modifications and variations are possible in light of the above teaching. It is intended that the scope of the present techniques and technologies be limited not by this detailed description. The present techniques and technologies may be embodied in other specific forms without departing from the spirit or essential characteristics thereof. Likewise, the particular naming and division of the modules, routines, features, attributes, methodologies and other aspects are not mandatory or significant, and the mechanisms that implement the present techniques and technologies or its features may have different names, divisions and/or formats. Furthermore, the modules, routines, features, attributes, methodologies and other aspects of the present invention can be implemented as software, hardware, firmware or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present techniques and technologies are in no way limited to implementation in any specific programming language, or for any specific operating system or environment. Accordingly, the disclosure of the present techniques and technologies is intended to be illustrative, but not limiting.

1. A method implemented by one or more computing devices, for providing tools for a user configurable and by which the user exports advertising data from an advertising database, comprising:
identifying, by at least one of the one or more computing devices, a set of basic advertising data in the advertising database for exporting to a final destination on an electronic device of a particular user;
providing, by at least one of the one or more computing devices, an instruction set and applying the instruction set to the set of basic advertising data in the advertising database and invoking a transformation of the set of basic advertising data through an export process;
generating a template, by at least one of the one or more computing devices, through which the user can configure the template and export the set of basic advertising data;
providing a user-interface to the user, by at least one of the one or more computing devices, configurable for the user to view the template and the user-interface including a capability within the user-interface, by which the user can define the template as the final destination for the set of basic advertising data; and
providing, by at least one of the one or more computing devices, a plurality of operational parameters configured to invoke export of the set of basic advertising data based on flexible criteria including timing for the export and a threshold level at which the export process begins.

2. The method of claim 1, wherein the template is a particular template from a list of templates that are compatible with an operating system of the electronic device used by the particular user.

3. The method of claim 1,
wherein the one or more operational parameters are automatically configured by the controller to invoke export of the advertising data based on flexible criteria.

4. The method of claim 3, wherein the flexible criteria includes a specified timing for the export process that is at least one of predetermined or updated as needed by the controller.

5. The method of claim 3, wherein the flexible criteria includes export based on a particular data value in a particular field in the advertising database serving as a threshold level, the export automatically initiating when a particular field in the advertising database reaches a certain threshold level.

6. The method of claim 1, wherein the user-interface presents a capability configurable to perform conditional logic on the data designated for export to create one or more new data elements to be exported, the new data elements derived from the advertising database from where the basic advertising data is designated to be extracted.

7. The method of claim 6, wherein the user-interface presents a capability configurable to specify controls on a plurality of fields to be exported, based at least in part, either on specific values of other data in the database from where the basic set of data is being exported or the data that is created.

8. The method of claim 8, wherein the user-interface presents a capability to the user configurable to specify transformations in each of the plurality of fields, of a data type and a format.

9. The method of claim 1, wherein the user-interface presents a capability to the user configurable and by which a controller specifies timing and transmission controls on the export and to build a process to automate regular transmissions.

10. The method of claim 1, wherein the user-interface presents a capability to the user configurable and by which a controller specifies a mode of export and a mode of signaling by which the end user is notified of a transmission status.

11. A method of claim 1, wherein the user-interface provides tools for a user that are configurable and by which a controller exports advertising data from an advertising database.

12. A computer-program product for providing tools for a user to export advertising data from an advertising database, the computer-program product comprising a non-transitory computer-usable medium including a computer-readable program, wherein the computer-readable program when executed on a computer causes the computer to:
identify a set of basic advertising data for exporting;
provide an instruction set to perform transformation of the set of basic advertising data through an export process;
generate a template for use by the user to export the set of basic advertising data; and
provide a user-interface to the user to allow the user to view the template for use by the user and including a capability within the user-interface, by which the user can define the template as a final destination for the advertising data; and
providing, by at least one of the one or more computing devices, a plurality of operational parameters configured to invoke export of the set of basic advertising data based on flexible criteria including timing for the export and a threshold level at which the export process begins.

13. The computer-program product of claim 12, wherein the template is a particular template from a list of templates that are compatible with an operating system of the electronic device used by the user.

14. The computer-program product of claim 12, wherein
the one or more operational parameters are automatically configured by a controller to invoke export of the advertising data based on flexible criteria.

15. The computer-program product of claim 14, wherein the flexible criteria includes a specified timing for the export process that is at least one of predetermined or updated as needed by the controller.

16. The computer-program product of claim 13, wherein the flexible criteria includes export based on a particular data value in a particular field in the advertising database serving as a threshold level, the export automatically initiating when a particular field in the advertising database reaches a certain threshold level.

17. The computer-program product of claim 13, wherein the user-interface presents a capability configurable and by which a controller performs conditional logic on the data designated for export to create one or more new data elements to be exported.

18. The computer-program product of claim 13, wherein the user-interface presents a capability configurable and by which a controller specifies controls on a plurality of fields to be exported, based at least in part, either on specific values of other data in the database from where the basic set of data is being exported or the data that is created.

19. The computer-program product of claim 13, wherein the user-interface presents a capability to the user configurable and by which a controller specifies transformations in each of the plurality of fields, of a data type and a format.

20. The computer-program product of claim 13, wherein the user-interface presents a capability to the user configurable and by which a controller specifies timing and transmission controls on the export and to build a process to automate regular transmissions.

21. The computer-program product of claim 13, wherein the user-interface presents a capability to the user configurable and by which a controller specifies a mode of export and a mode of signaling by which an end user is notified of a transmission status.

22. The computer-program product of claim 13, wherein the user-interface provides tools for a user that are configurable and by which a controller exports advertising data from an advertising database.

23. A system for providing tools for a user to export advertising data from an advertising database, comprising:
a processor; and
a memory storing instructions that when executed cause the processor to:
identify a set of basic advertising data for exporting;
provide an instruction set to perform transformation of the set of basic advertising data through an export process;
generate a template for use by the user to export the basic set of advertising data; and
provide a user-interface to the user to allow the user to view the template for use by the user and including a capability within the user-interface, by which the user can define the template as a final destination for the advertising data; and
provide a plurality of operational parameters configured to invoke export of the set of basic advertising data based on flexible criteria including timing for the export and a threshold level at which the export process begins.

24. The system of claim 23, wherein the template is a particular template from a list of templates that are compatible with an operating system of the electronic device used by the user.

25. The system of claim 23, wherein
the one or more operational parameters are automatically configured by a controller to invoke export of the advertising data based on flexible criteria.

26. The system of claim 25, wherein the flexible criteria includes a specified timing for the export process that is at least one of predetermined or updated as needed by the controller.

27. The system of claim 25, wherein the flexible criteria includes export based on a particular data value in a particular field in the advertising database serving as a threshold level, the export automatically initiating when a particular field in the advertising database reaches a certain threshold level.

28. The system of claim 25, wherein the user-interface presents a capability configurable and by which a controller performs conditional logic on the data designated for export to create one or more new data elements to be exported.

29. The system of claim 25, wherein the user-interface presents a capability configurable and by which a controller specifies controls on a plurality of fields to be exported, based at least in part, either on specific values of other data in the database from where the basic set of data is being exported or the data that is created.

30. The system of claim 25, wherein the user-interface presents a capability to the user configurable and by which a controller specifies transformations in each of the plurality of fields, of a data type and a format.

31. The system of claim 25, wherein the user-interface presents a capability to the user configurable and by which a controller specifies timing and transmission controls on the export and to build a process to automate regular transmissions.

32. The system of claim 25, wherein the user-interface presents a capability to the user configurable and by which a controller specifies a mode of export and a mode of signaling by which an end user is notified of a transmission status.

33. The system of claim 25, wherein the user-interface provides tools for a user configurable and by which a controller exports advertising data from an advertising database.
